(19) United States
(12) Patent Application Publication
(10) Pub. No.: US 2024/0305150 A1
(43) Pub. Date: Sep. 12, 2024

(54) ROTOR, ELECTRIC MOTOR, COMPRESSOR, REFRIGERATION CYCLE DEVICE, AND AIR CONDITIONER

(71) Applicant: Mitsubishi Electric Corporation, Tokyo (JP)

(72) Inventor: Kazuhiko BABA, Tokyo (JP)

(21) Appl. No.: 18/254,653

(22) PCT Filed: Dec. 25, 2020
(86) PCT No.: PCT/JP2020/048654

§ 371 Date: May 26, 2023

(51) Int. Cl. H02K 1/276; F25B 31/02; H02K 21/16

(52) U.S. Cl. CPC H02K 1/276; F25B 31/026; H02K 21/16; F25B 2500/16

(57) ABSTRACT

A rotor includes a first core, a second core, and two or more permanent magnets. The first core includes a first magnet accommodation hole, a first air hole, and a thin-core part. The second core includes a second magnet accommodation hole communicating with the first magnet accommodation hole, and a second air hole communicating with both of the second magnet accommodation hole and the first air hole. A first permanent magnet and a second permanent magnet of the two or more permanent magnets are disposed in the first magnet accommodation hole and the second magnet accommodation hole. A first space is provided between the first permanent magnet and the second permanent magnet.

### CROSS-REFERENCE TO RELATED APPLICATION

This application is a U.S. National Stage Application of International Application No. PCT/JP2020/048654 filed on Dec. 25, 2020, the contents of which are incorporated herein by reference.

### TECHNICAL FIELD

The present disclosure relates to a rotor, an electric motor, a compressor, a refrigeration cycle device, and an air conditioner.

### BACKGROUND

A widespread refrigeration cycle device includes a compressor that compresses a refrigerant, and a refrigerant channel in which the refrigerant compressed by the compressor flows. The compressor includes an electric motor and a compression mechanism that is driven by the electric motor (see, for example, Patent Literature 1). The electric motor of the compressor disclosed in Patent Literature 1 includes a stator and a rotor including permanent magnets.

### PATENT REFERENCE

Patent Reference 1: International Patent Publication No. 2017/072967 (see, for example, paragraphs 0139, 0140, and 0142, FIGS. 2, 3, 4, 5, 8, 26, and 27)

In Patent Literature 1, in the case of using a mixed refrigerant including an HFO refrigerant showing low greenhouse effect or an HC refrigerant described above, since the refrigerant has a small density, the operation pressure of the compressor decreases. Thus, in the conventional technique, to obtain equivalent performance with the same compressor stroke volume as that of an HFC refrigerant such as R32, it is necessary to increase the number of rotations to increase the flow rate of the refrigerant. If the flow rate of the refrigerant is increased, however, the flow velocity of a refrigerant flowing in an air flow (corresponding to a gap 28 in Patent Literature 1) of the rotor of the electric motor increases. Consequently, separation of the refrigerant and oil (e.g., refrigerating machine oil) becomes difficult, and thus oil in the compressor flows out of the compressor, resulting in the possibility of poor lubrication in the compression mechanism.

### SUMMARY

It is therefore an object of the present disclosure to prevent poor lubrication in the compression mechanism of the compressor.

A rotor according to an aspect of the present disclosure includes: at least one first core; at least one second core; and two or more permanent magnets, wherein the at least one first core includes a first magnet accommodation hole, a first air hole located apart from the first magnet accommodation hole inward in a radial direction, and a thin-core part located between the first magnet accommodation hole and the first air hole, the at least one second core includes a second magnet accommodation hole axially communicating with the first magnet accommodation hole, and a second air hole communicating with both of the second magnet accommodation hole and the first air hole,
a first permanent magnet and a second permanent magnet of the two or more permanent magnets are disposed in the first magnet accommodation hole and the second magnet accommodation hole, and a first space is provided between the first permanent magnet and the second permanent magnet that are disposed in the first magnet accommodation hole and the second magnet accommodation hole.

An electric motor according to another aspect of the present disclosure includes: a stator; and the rotor disposed inside the stator.

A compressor according to another aspect of the present disclosure includes: the electric motor; a compression mechanism; and a crankshaft couples the compression mechanism and the electric motor together.

A refrigeration cycle device according to the present disclosure includes: the compressor to compress refrigerant; and a refrigerant channel in which the refrigerant compressed by the compressor flows.

An air conditioner according to another aspect of the present disclosure includes: the compressor; an outdoor heat exchanger; and an indoor heat exchanger.

According to the present disclosure, poor lubrication in the compression mechanism of the compressor can be prevented.

### BRIEF DESCRIPTION OF THE DRAWINGS

FIG. 1 is a diagram illustrating a configuration of a refrigerant circuit in cooling operation of an air conditioner.

FIG. 2 is a diagram illustrating a configuration of the refrigerant circuit in heating operation of the air conditioner.

FIG. 3 is a cross-sectional view illustrating a configuration of a compressor.

FIG. 4 is a cross-sectional view illustrating a configuration of a compression mechanism.

FIG. 5 is a cross-sectional view illustrating a configuration of an electric motor.

FIG. 6 is a cross-sectional view illustrating a first core.

FIG. 7 is a cross-sectional view illustrating a second core.

FIG. 8 is a cross-sectional view illustrating the first core in which permanent magnets are disposed.

FIG. 9 is a cross-sectional view illustrating the second core in which permanent magnets are disposed.

FIG. 10 is a cross-sectional view of a rotor core taken along line B1-O-B2 in FIGS. 6 and 7.

FIG. 11 is a plan view illustrating a configuration of a +z side of a first end plate.

FIG. 12 is a plan view illustrating a configuration of a +z side of a second end plate.

FIG. 13 is a cross-sectional view illustrating another example of the rotor.

FIG. 14 is a cross-sectional view illustrating yet another example of the rotor.

FIG. 15 is a cross-sectional view illustrating still another example of the rotor.

FIG. 16 is a cross-sectional view illustrating still another example of the rotor.

FIG. 17 is a cross-sectional view illustrating still another example of the rotor.

FIG. 18 is a cross-sectional view illustrating still another example of the rotor.

FIG. 19 is a cross-sectional view illustrating still another example of the rotor.

FIG. 20 is a cross-sectional view illustrating still another example of the rotor.

FIG. 21 is a cross-sectional view illustrating still another example of the rotor.

### DETAILED DESCRIPTION

A refrigeration cycle device and an air conditioner 100 will be described hereinafter with reference to the drawings.

The type of “refrigerant” herein will be described using refrigerant numbers beginning with “R” specified by the International Standard ISO 817.

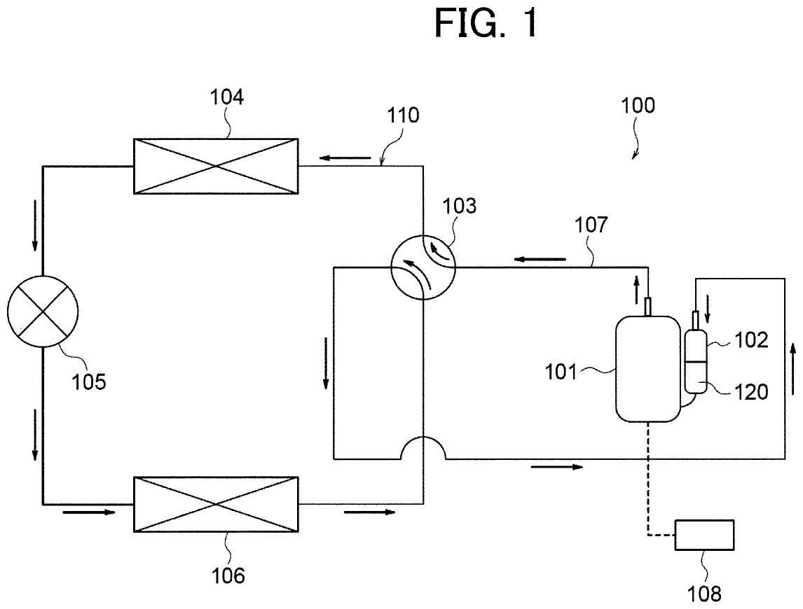

FIG. 1 is a diagram illustrating a configuration of a refrigerant circuit in cooling operation of the air conditioner 100.

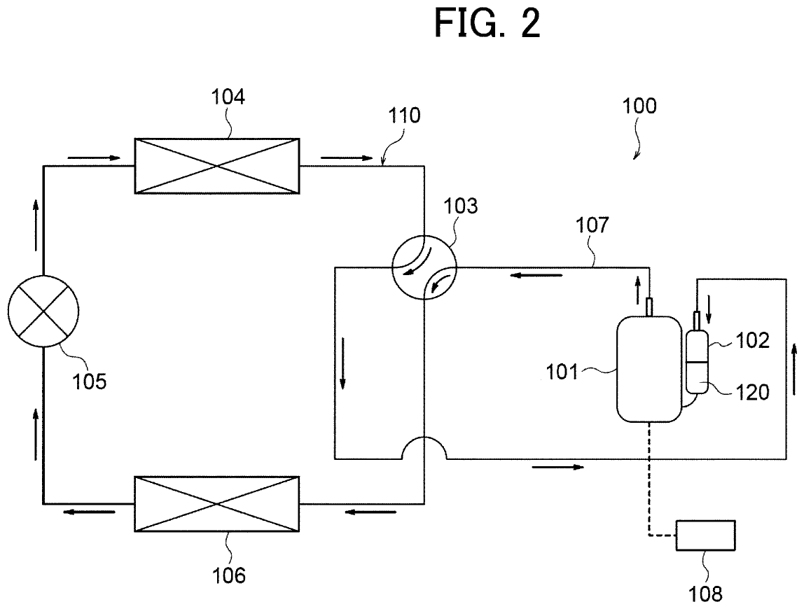

FIG. 2 is a diagram illustrating a configuration of the refrigerant circuit in heating operation of the air conditioner 100.

### <Refrigeration Cycle Device>

A refrigeration cycle device according to this embodiment includes a compressor 101 that compresses a refrigerant 120, and a refrigerant channel 110 in which the refrigerant 120 compressed by the compressor 101 flows. This refrigeration cycle device may be applied to a device other than the air conditioner 100. For example, the refrigeration cycle device may be applied to a device such as a refrigerator or a heat pump cycle device.

### <Air Conditioner>

In this embodiment, the air conditioner 100 to which the refrigeration cycle device is applied will be described.

As illustrated in FIGS. 1 and 2, the air conditioner 100 includes the refrigerant 120, the compressor 101 that compresses the refrigerant 120, and the refrigerant channel 110 in which the refrigerant 120 compressed by the compressor 101 flows.

The refrigerant channel 110 includes an accumulator 102, a four-way valve 103 for switching between cooling operation and heating operation, an outdoor heat exchanger 104, an expansion valve 105 as a decompressor, an indoor heat exchanger 106, and pipes 107. The compressor 101, the accumulator 102, the outdoor heat exchanger 104, the expansion valve 105, and the indoor heat exchanger 106 are connected to one another by the pipes (e.g., copper pipes) 107. The compressor 101, the outdoor heat exchanger 104, the expansion valve 105, and the indoor heat exchanger 106 constitute the refrigerant circuit.

The air conditioner 100 further includes a control part 108. The control part 108 controls, for example, a pressure and a temperature in the compressor 101. The control part 108 is, for example, a microcomputer. The control part 108 may control elements other than the compressor 101, such as the four-way valve 103.

Operation of the air conditioner 100 in cooling operation will now be described. As illustrated in FIG. 1, the compressor 101 compresses the refrigerant 120 sucked from the accumulator 102 and sends the compressed refrigerant 120 as a high-temperature and high-pressure refrigerant gas. The four-way valve 103 causes the high-temperature and high-pressure refrigerant gas sent from the compressor 101 to flow in the outdoor heat exchanger 104. The outdoor heat exchanger 104 performs heat exchange between the high-temperature and high-pressure refrigerant gas and a medium (e.g., air) to thereby condense the refrigerant gas and send the condensed gas as a low-temperature and high-pressure liquid refrigerant. That is, in the cooling operation, the outdoor heat exchanger 104 functions as a condenser.

The expansion valve 105 expands the liquid refrigerant from the outdoor heat exchanger 104 and sends the expanded liquid refrigerant as a low-temperature and low-pressure liquid refrigerant. Specifically, the low-temperature and high-pressure liquid refrigerant sent from the outdoor heat exchanger 104 is decompressed by the expansion valve 105 to thereby become a two-phase state of a low-temperature and low-pressure refrigerant gas and a low-temperature and low-pressure liquid refrigerant. The indoor heat exchanger 106 performs heat exchange between the refrigerant in the two-phase state sent from the expansion valve 105 and the medium (e.g., air), evaporates the liquid refrigerant, and sends the refrigerant gas. That is, in the cooling operation, the indoor heat exchanger 106 functions as an evaporator. The refrigerant gas sent from the indoor heat exchanger 106 returns to the compressor 101 through the accumulator 102. As described above, in the cooling operation, the refrigerant 120 circulates in the refrigerant circuit along a path indicted by arrows in FIG. 1. That is, in the cooling operation, the refrigerant 120 circulates in the order of the compressor 101, the outdoor heat exchanger 104, the expansion valve 105, and the indoor heat exchanger 106.

Switching between the cooling operation and the heating operation is performed by switching a flow channel with the four-way valve 103 as illustrated in FIG. 2. That is, in the heating operation, the indoor heat exchanger 106 functions as a condenser, and the outdoor heat exchanger 104 functions as an evaporator.

### <Refrigerant>

Next, the refrigerant 120 will be described. The refrigerant 120 is a mixed refrigerant including ethylene-based fluorocarbon having a double bond of carbon. The mixed refrigerant including ethylene-based fluorocarbon having a double bond of carbon can reduce a working pressure to prevent disproportionation. In this embodiment, the refrigerant 120 is a mixed refrigerant including R1123 (i.e., 1, 1, 2-trifluoroethylene). The refrigerant 120 is not limited to R1123, and may be a mixed refrigerant including another ethylene-based fluorocarbon.

It is sufficient for the refrigerant 120 to include one or more types of ethylene-based fluorocarbon. In this case, the refrigerant 120 is, for example, a mixed refrigerant in which ethylene-based fluorocarbon is mixed with another refrigerant. For example, the refrigerant 120 is a mixed refrigerant in which R1123 and R32 (difluoromethane) are mixed. A proportion of R1123 in this mixed refrigerant is preferably set within the range from 40 wt % to 60 wt %, for example. It should be noted that R1123 may be mixed with a refrigerant other than R32. For example, R1123 may be mixed with one or more refrigerants of R1234yf (i.e., 2, 3, 3, 3-tetrafluoropropene), R1234ze (E) (i.e., trans-1, 3, 3, 3-tetrafluoropropene), R1234ze (Z) (i.e., sis-1, 3, 3, 3-tetrafluoropropene), R125 (1, 1, 1, 2-pentafluoroethane), and R134a (i.e., 1, 1, 1, 2-tetrafluoroethane).

The refrigerant 120 may be a refrigerant including two or more types of ethylene-based fluorocarbon. For example, R1123 may be mixed with one or more types of ethylene-based fluorocarbon of R1141 (i.e., fluoroethylene), R1132a (i.e., 1, 1-difluoroethylene), R1132 (E) (i.e., trans-1, 2-difluoroethylene), and R1132 (Z) (i.e., sis-1, 2-difluoroethylene).

As another refrigerant, the refrigerant 120 may be R290 constituted by hydrocarbon, that is, propane.

### <Compressor Configuration>

Next, the compressor 101 will be described.

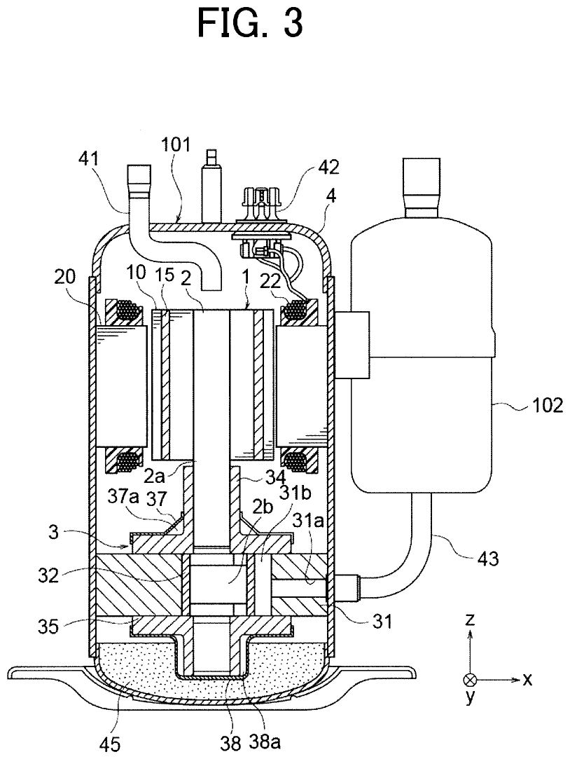

FIG. 3 is a cross-sectional view illustrating a configuration of the compression 101. The compressor 101 is, for example, a rotary compressor. The compressor 101 may be a compressor other than the rotary compressor. For example, the compressor 101 may be a low-pressure compressor or a scroll compressor.

As illustrated in FIG. 3, the compressor 101 includes an electric motor 1, a crankshaft 2 as a rotation shaft, a compression mechanism 3, and a sealed container 4. The electric motor 1 drives the compression mechanism 3. The compression mechanism 3 compresses the refrigerant 120 sucked from the accumulator 102. Configurations of the electric motor 1 and the compression mechanism 3 will be described later.

The crankshaft 2 couples the electric motor 1 and the compression mechanism 3 together. The crankshaft 2 includes a shaft body part 2a fixed to a rotor 10 of the electric motor 1 and an eccentric shaft part 2b fixed to both of a rolling piston 32 of the compression mechanism 3 and the shaft body part 2a.

In the following description, a direction R1 along a circumference of a circle about the rotation center of the rotor 10 will be referred to as a “circumferential direction,” a direction along an axis C1 that is the rotation center of the rotor 10 will be referred to as an “axial direction of the rotor 10,” “an axial direction of the electric motor 1,” or simply as an “axial direction,” and a direction along the radius of the rotor 10 will be referred to as a “radial direction.” For example, the radial direction is a direction orthogonal to the axial direction and extending along a line passing through the crankshaft 2. In some drawings, an xyz orthogonal coordinate system is shown in order to facilitate understanding of relationship among the drawings. The z axis is a coordinate axis parallel to the axis C1. The y axis is a coordinate axis orthogonal to the z axis. The x axis is a coordinate axis orthogonal to both of the y axis and the z axis. The xy plane is a plane orthogonal to the axial direction.

The sealed container 4 has a cylindrical shape, and accommodates the electric motor 1 and the compression mechanism 3. An oil sump part 45 provided at the bottom of the sealed container 4 stores refrigerating machine oil. The refrigerating machine oil is lubricating oil for lubricating a sliding part of the compression mechanism 3. The sliding part of the compression mechanism 3 is, for example, a part in which the rolling piston 32 is fitted onto the eccentric shaft part 2b. The refrigerating machine oil flows through an oil supply passage formed in the crankshaft 2 and lubricates the sliding part of the compression mechanism 3.

The compressor 101 further includes a discharge pipe 41 and a terminal 42. The discharge pipe 41 and the terminal 42 are attached to an upper portion of the sealed container 4. The refrigerant 120 compressed by the compression mechanism 3 is discharged to the outside of the sealed container 4 through the discharge pipe 41. The discharge pipe 41 is connected to the refrigerant circuit illustrated in FIG. 1 or FIG. 2.

The terminal 42 is connected to a driving device (not shown) provided outside the compressor 101. The terminal 42 supplies a driving current to a coil 22 of a stator 20 of the electric motor 1 through a lead wire 44. Accordingly, magnetic flux occurs in the coil 22, and thus the rotor 10 of the electric motor 1 rotates.

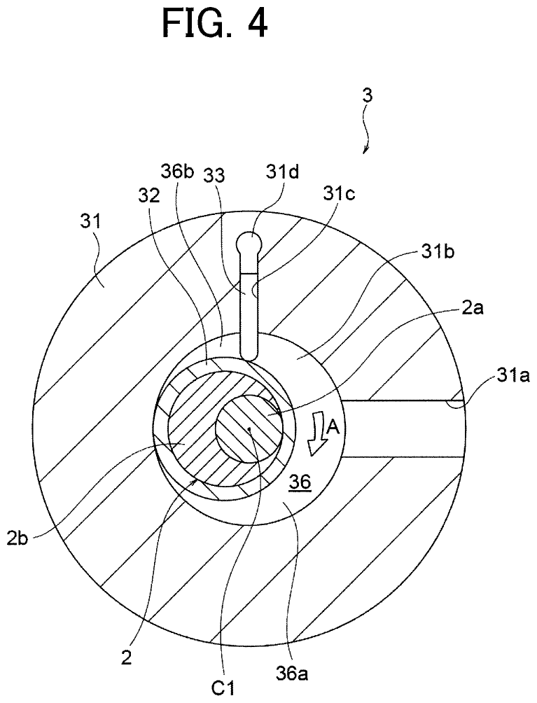

FIG. 4 is a cross-sectional view illustrating a configuration of the compression mechanism 3.

As illustrated in FIGS. 3 and 4, the compression mechanism 3 includes a cylinder 31, the rolling piston 32, a vane 33, an upper bearing 34, and a lower bearing 35. The cylinder 31 includes a suction port 31a, a cylinder chamber 31b, and a vane groove 31c. The suction port 31a communicates with the accumulator 102 through a suction pipe 43. The suction port 31a is a passage in which the refrigerant 120 sucked from the accumulator 102 flows, and communicates with the cylinder chamber 31b.

The cylinder chamber 31b is a cylindrical space about the axis C1. The cylinder chamber 31b houses the eccentric shaft part 2b of the crankshaft 2, the rolling piston 32, and the vane 33. The rolling piston 32 of the rolling piston 32 when seen in the z-axis direction is a ring shape. The rolling piston 32 is fixed to the eccentric shaft part 2b of the crankshaft 2.

The vane groove 31c communicates with the cylinder chamber 31b. The vane 33 is attached to the vane groove 31c. A back-pressure chamber 31d is formed in an end portion of the vane groove 31c. The vane 33 is, for example, pressed by a spring disposed in the back-pressure chamber 31d toward the axis C1 to be thereby brought into contact with an outer peripheral surface of the rolling piston 32. Accordingly, the vane 33 divides a space 36 surrounded by an inner peripheral surface of the cylinder chamber 31b, the outer peripheral surface of the rolling piston 32, the upper bearing 34, and the lower bearing 35 into a suction-side working chamber 36a and a compression-side working chamber 36b. The suction-side working chamber 36a will also be referred to as a suction chamber 36a, and the compression-side working chamber 36b will also be referred to as a compression chamber 36b. The suction chamber 36a communicates with the suction port 31a.

In the example illustrated in FIG. 4, while the rolling piston 32 eccentrically rotates, the vane 33 reciprocates in the y-axis direction in the vane groove 31c. The vane 33 has a plate shape, for example. In the example illustrated in FIG. 4, the rolling piston 32 and the vane 33 are separate components, but the rolling piston 32 and vane 33 may be integrally formed as one component.

The upper bearing 34 closes an end portion of the cylinder chamber 31b on the +z-axis side. The lower bearing 35 closes an end portion of the cylinder chamber 31b on the −z-axis side. The upper bearing 34 and the lower bearing 35 are fixed to the cylinder 31 by fastening members (e.g., bolts).

Each of the upper bearing 34 and the lower bearing 35 has a discharge port from which the compressed refrigerant is discharged to the outside of the cylinder chamber 31b. The discharge port of each of the upper bearing 34 and the lower bearing 35 communicates with the compression chamber 36b of the cylinder chamber 31b. Each of the discharge ports includes, for example, a discharge port. When the pressure of the refrigerant compressed in the compression chamber 36b increases to a predetermined pressure or more, the discharge valve opens and consequently the high-temperature and high-pressure refrigerant is discharged to inner space of the sealed container 4. The lower bearing 35 does not need to include the discharge port.

An upper discharge muffler 37 is attached to the upper bearing 34 with a fastening member (e.g., a bolt). A muffler chamber 37a is disposed between the upper bearing 34 and the upper discharge muffler 37. Accordingly, the refrigerant discharged from the discharge port of the upper bearing 34 is diffused in the muffler chamber 37a, and thus, occurrence of discharge noise of the refrigerant discharged from the discharge port of the upper bearing 34 can be suppressed.

A lower discharge muffler 38 is attached to the lower bearing 35 with a fastening member (e.g., a bolt). A muffler chamber 38a is disposed between the lower bearing 35 and the lower discharge muffler 38. Accordingly, the refrigerant discharged from the discharge port of the lower bearing 35 is diffused in the muffler chamber 38a, and thus, occurrence of discharge noise of the refrigerant discharged from the lower bearing 35 can be suppressed. In a case where only one of the upper bearing 34 and the lower bearing 35 has a discharge port, a discharge muffler may be attached to the frame having the discharge port.

### <Electric Motor>

Next, a configuration of the electric motor 1 will be described.

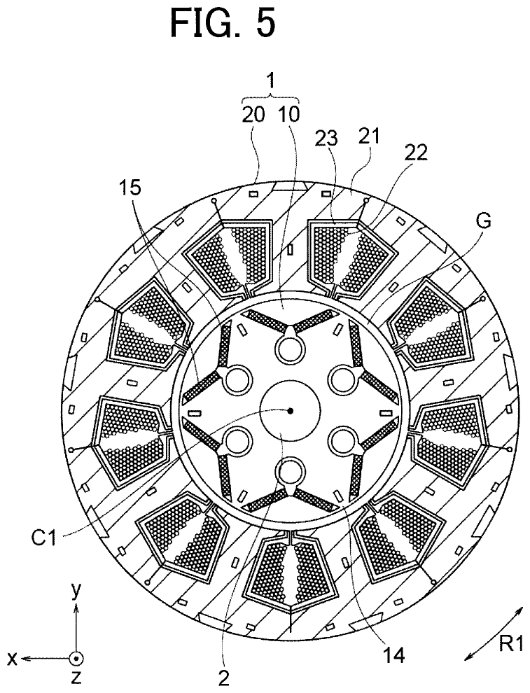

FIG. 5 is a cross-sectional view illustrating the configuration of the electric motor 1. As illustrated in FIG. 5, the electric motor 1 includes the rotor 10 and the stator 20. The rotor 10 is rotatably disposed inside the stator 20. In the example illustrated in FIG. 5, the electric motor 1 is an inner-rotor motor. A gap G is present between the rotor 10 and the stator 20. The gap G has a predetermined width in the range from 0.3 mm to 1.0 mm, for example.

### <Stator>

A configuration of the stator 20 will now be described. As illustrated in FIG. 5, the stator 20 includes a stator core 21, the coil 22 as a winding wound around the stator core 21, and an insulator 23 that insulates the stator core 21. Although FIG. 5 shows an example of concentrated winding, the coil 22 may be wound around the stator core 21 by distributed winding. The stator core 21 is fixed to the inner wall of the sealed container 4 illustrated in FIG. 3. The stator core 21 is fixed to the inner wall of the sealed container 4 by press fitting, shrink fitting, or welding, for example.

### <Rotor>

A configuration of the rotor 10 will now be described.

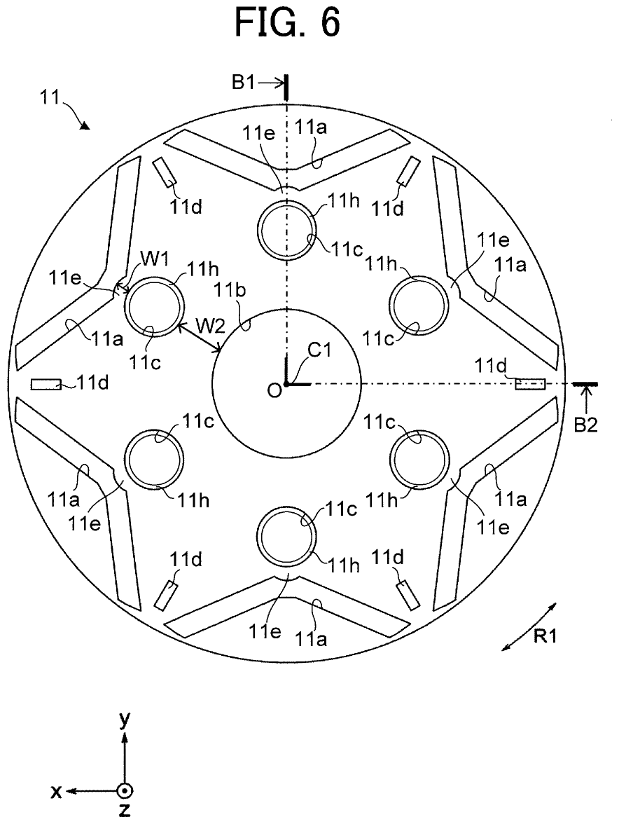

FIG. 6 is a cross-sectional view illustrating a first core 11.

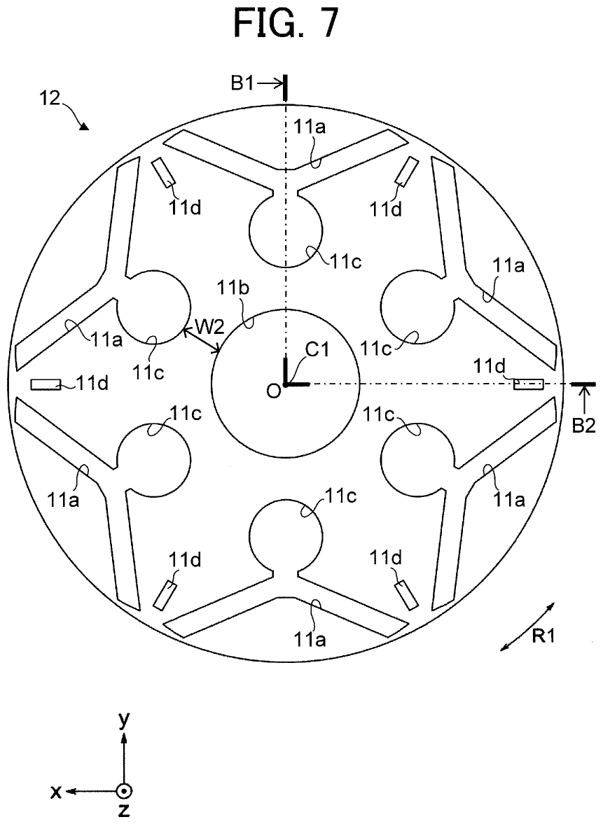

FIG. 7 is a cross-sectional view illustrating a second core 12.

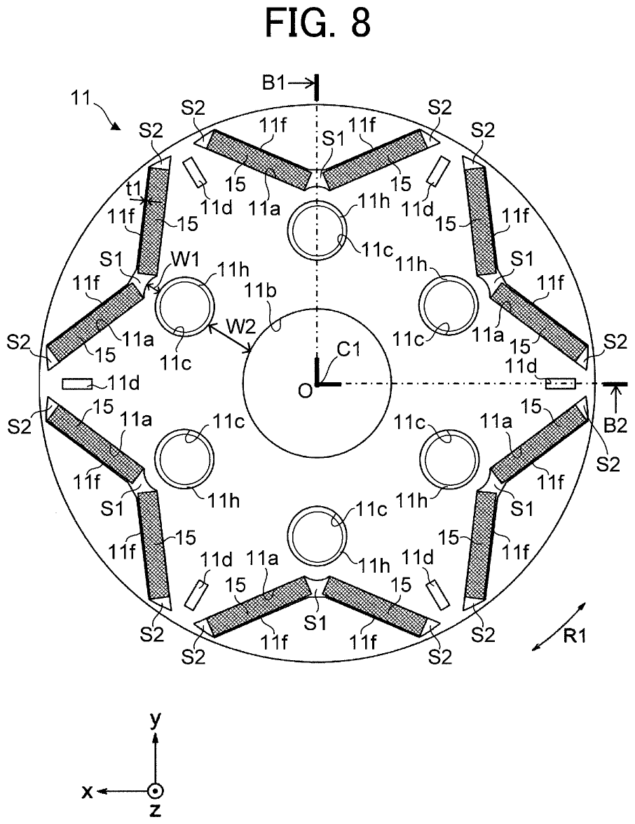

FIG. 8 is a cross-sectional view illustrating the first core 11 in which permanent magnets 15 are disposed.

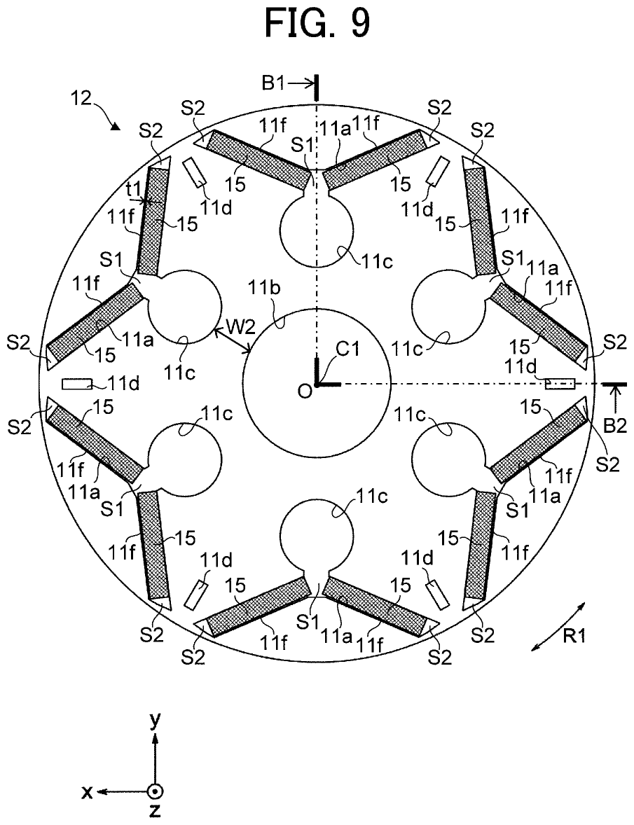

FIG. 9 is a cross-sectional view illustrating the second core 12 in which permanent magnets 15 are disposed.

The rotor 10 includes a rotor core 14 including at least one first core 11 and at least one second core 12. The rotor 10 further includes two or more permanent magnets 15 disposed in the rotor core 14. In this embodiment, the rotor 10 includes a plurality of first cores 11, a plurality of second cores 12, and a plurality of permanent magnets 15.

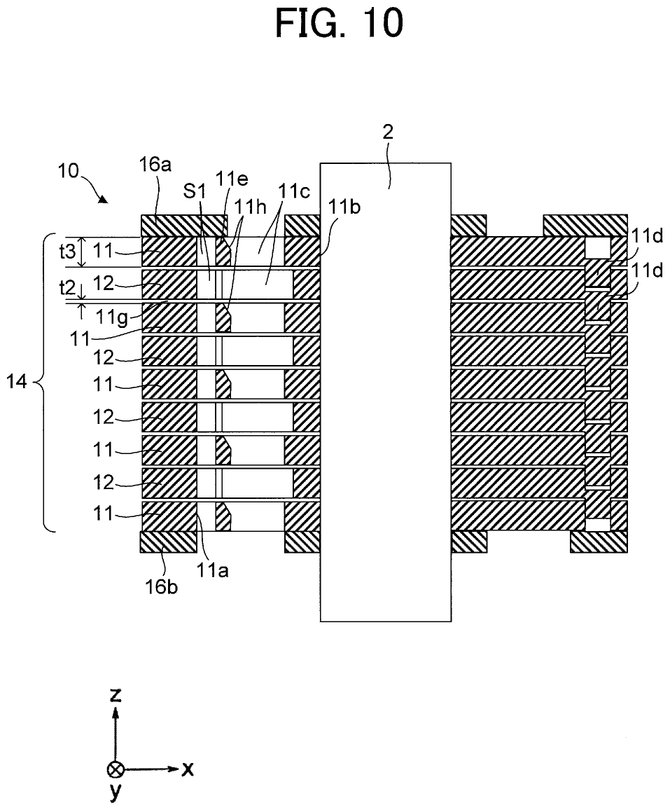

FIG. 10 is a cross-sectional view of the rotor core 14 taken along line B1-O-B2 illustrated in FIGS. 6 and 7. In the example illustrated in FIG. 10, the rotor core 14 is constituted by the plurality of first cores 11 and the plurality of second cores 12.

The rotor core 14 includes a plurality of magnet accommodation holes 11a separated from one another in the circumferential direction R1. When seen in the z-axis direction, the shape of each of the magnet accommodation holes 11a is a V shape. That is, in the xy plane, the shape of each magnet accommodation hole 11a is a V shape. As illustrated in FIGS. 8 and 9, two permanent magnets 15 are disposed in each magnet accommodation hole 11a. In each magnet accommodation hole 11a, a space S1 is provided between the two permanent magnets 15. The space S1 will also be referred to as a first space S1. The two permanent magnets 15 disposed in each magnet accommodation hole 11a will also be referred to as a first permanent magnet 15 and a second permanent magnet 15. In the xy plane, two permanent magnets 15 in each magnet accommodation hole 11a are disposed in a V shape.

In the example illustrated in FIGS. 6 through 9, the rotor core 14 includes six magnet accommodation holes 11a. That is, each first core 11 includes six magnet accommodation holes 11a, and each second core 12 also includes six magnet accommodation holes 11a.

The magnet accommodation holes 11a disposed in each first core 11 will also be referred to as first magnet accommodation holes 11a, and the magnet accommodation holes 11a disposed in each second core 12 will also be referred to as second magnet accommodation holes 11a. That is, the magnet accommodation holes 11a of the rotor core 14 are formed by one or more first magnet accommodation holes 11a and one or more second magnet accommodation holes 11a. In each of the first magnet accommodation holes 11a, the space S1 between two permanent magnets 15 will also be referred to as a first space S1, and in each of the second magnet accommodation holes 11a, the space S1 between two permanent magnets 15 will also be referred to as a first space S1.

The number of magnetic poles of the electric motor 1 is equal to the number of the magnet accommodation holes 11a. In this embodiment, the number of the magnetic poles of the electric motor 1 is six. Thus, the number of magnetic poles of the rotor 10 is six, and the number of the magnet accommodation holes 11a is six. The number of the magnet accommodation holes 11a is not limited to six, and only needs to be two or more.

As described above, the permanent magnets 15 are embedded in the magnet accommodation holes 11a. Thus, in this embodiment, the rotor 10 has an interior permanent magnet (IPM) structure.

The shape of each of the permanent magnets 15 is, for example, a plate shape. The permanent magnets 15 are, for example, rare earth magnets. The permanent magnets 15 are, for example, rare earth magnets including neodymium (Nd), iron (Fe), and boron (B). In this embodiment, each permanent magnet 15 includes none of dysprosium (Dy) and terbium (Tr). Dysprosium and terbium are rare earth resources, and therefore, are expensive. In this embodiment, the dysprosium content and the terbium content in the permanent magnets 15 are 0 wt. %, and thus, costs for the permanent magnets 15 can be reduced. The permanent magnets 15 may include less than 1.0 wt. % of dysprosium or less than 1.0 wt. % of terbium, or both of them. The permanent magnets 15 are not limited to rare earth magnets, and may be other permanent magnets such as ferrite magnets.

The rotor core 14 includes a shaft hole 11b in which the crankshaft 2 is disposed, a plurality of air holes 11c, and a plurality of caulked parts 11d. In this embodiment, the number of the air holes 11c is equal to the number of the magnet accommodation holes 11a. Each air hole 11c is disposed between the magnet accommodation hole 11a and the shaft hole 11b. Each air hole 11c is located at a position facing the first space S1. Specifically, each air hole 11c is located at a position facing the inner side of the first space S1 in the radial direction.

In this embodiment, the shape of each of the air holes 11c in the xy plane is a circle, but is not limited to the circle. For example, the shape of each air hole 11c in the xy plane may be an oval, or may be a curve, a straight line, or a shape formed by a combination thereof. The area of each air hole 11c in the xy plane is preferably sufficiently larger than that of the first space S1. For example, the area of each air hole 11c in the xy plane is 10 times or more as large as the area of each first space S1.

### <First Core>

As illustrated in FIG. 6, each first core 11 includes at least one first magnet accommodation hole 11a, the shaft hole 11b, at least one air hole 11c (also referred to as a first air hole 11c), and at least one thin-core part 11e. Each first air hole 11c is located apart from the first magnet accommodation hole 11a inward in the radial direction. Each thin-core part 11e is located between the first magnet accommodation hole 11a and the first air hole 11c. Each thin-core part 11e will also be referred to as a bridge part or a first bridge part.

In the xy plane, the shape of each first magnet accommodation hole 11a is a V shape.

As described above, in this embodiment, the shape of each first air hole 11c in the xy plane is a circle, but is not limited to the circle. For example, the shape of each first air hole 11c in the xy plane may be an oval, or may be a curve, a straight line, or a shape formed by a combination thereof. The area of the first air holes 11c in the xy plane is preferably sufficiently larger than that of the first spaces S1. For example, the area of each air hole 11c in the xy plane is 10 times or more as large as the area of each first space S1.

Each first core 11 includes the at least one thin-core part 11e, and the area of each first air hole 11c in the xy plane is 10 times or more as large as that of each first space S1. This configuration can facilitate separation of the refrigerant 120 and the refrigerating machine oil in the compressor 101. The configuration can also guide the separated refrigerating machine oil to the first spaces S1.

Each first air hole 11c is located closer to the first space S1 than the shaft hole 11b is. Each thin-core part 11e is a portion of the first core 11 located between the first air hole 11c and the first space S1. In the example illustrated in FIG. 6, in the xy plane, the shape of each thin-core part 11e is an arc shape, and the thin-core part 11e extends along the inner wall of the first air hole 11c. In the example illustrated in FIG. 6, in the xy plane, a width W1 of each thin-core part 11e is uniform along the inner wall of the first air hole 11c. That is, each thin-core part 11e extends with the uniform width W1 along the inner wall of the first air hole 11c. The width W1 of each thin-core part 11e is preferably greater than or equal to the thickness of each first core 11 in the axial direction. In the case where the width W1 of each thin-core part 11e is greater than or equal to the thickness of each first core 11 in the axial direction, sufficient strength of the first core 11 can be obtained.

As illustrated in FIG. 8, the first core 11 includes clearances 11f each provided between each first magnet accommodation hole 11a and the corresponding permanent magnet 15, and second spaces S2 each provided in an end portion of the first magnet accommodation hole 11a in the circumferential direction of the rotor 10. The clearances 11f of the first core 11 will also be referred to as first clearances 11f. Each second space S2 of the first core 11 communicates with the corresponding first clearance 11f. Each first clearance 11f of each first core 11 communicates with the corresponding first space S1.

In the example illustrated in FIG. 8, the second spaces S2 are located in both end portions of each first magnet accommodation hole 11a in the circumferential direction. A region between each second space S2 and the outer peripheral surface of the rotor core 14 is a thin part (also referred to as a bridge part or a second bridge part), and this thin part reduces magnetic flux leakage in a region between adjacent magnetic poles. While the electric motor 1 is disposed in the compressor 101, each second space S2 functions as a path in which refrigerating machine oil flows.

In the xy plane, the length of each permanent magnet 15 in the lateral direction is shorter than the length of each first magnet accommodation hole 11a in the lateral direction. Accordingly, the clearance 11f is provided between the first magnet accommodation hole 11a and the permanent magnet 15. A width t1 of each clearance 11f in the lateral direction of the first magnet accommodation hole 11a is, for example, 0.1 mm to 0.2 mm. Each clearance 11f is located on the outer side or inner side with respect to corresponding permanent magnet 15 in the radial direction of the rotor 10. If each clearance 11f of the first core 11 is located at the outer side of each permanent magnet 15 in the radial direction of the rotor 10, cooling effect on the permanent magnet 15 can be further enhanced.

### <Second Core>

As illustrated in FIG. 7, each second core 12 includes at least one second magnet accommodation hole 11a, the shaft hole 11b, and at least one air hole 11c (also referred to as second air hole 11c). Each second air hole 11c is located on the inner side with respect to corresponding second magnet accommodation hole 11a in the radial direction, and communicates with this second magnet accommodation hole 11a. Each second magnet accommodation hole 11a communicates with corresponding first magnet accommodation hole 11a of the first core 11. Specifically, each second air hole 11c communicates with the center of corresponding second magnet accommodation hole 11a in the xy plane. Thus, each second air hole 11c communicates with both of corresponding first magnet accommodation hole 11a and corresponding second magnet accommodation hole 11a. Specifically, each second air hole 11c communicates with corresponding second magnet accommodation hole 11a in the radial direction, and communicates with corresponding first magnet accommodation hole 11a of the first core 11 in the axial direction. In the xy plane, the area of each second air hole 11c communicating with corresponding first air hole 11c of the first core 11 is larger than the area of this first air hole 11c. In other words, in the xy plane, the diameter of each second air hole 11c communicating with corresponding first air hole 11c of the first core 11 is larger than the diameter of this first air hole 11c.

In the xy plane, the shape of each second magnet accommodation hole 11a is a V shape. Two permanent magnets 15 are disposed in each magnet accommodation hole 11a of the rotor core 14. Two permanent magnets 15 disposed in each magnet accommodation hole 11a will also be referred to as a “first permanent magnet 15” and a “second permanent magnet 15.” That is, a pair of the first permanent magnet 15 and the second permanent magnet 15 is disposed in one or more first magnet accommodation holes 11a and one or more second magnet accommodation holes 11a communicating with each other in the axial direction. As described above, the first space S1 is provided between the first permanent magnet 15 and the second permanent magnet 15 disposed in each magnet accommodation hole 11a.

As described above, in this embodiment, the shape of the second air hole 11c in the xy plane is a circle, but is not limited to the circle. For example, the shape of the second air hole 11c in the xy plane may be an oval, or may be a curve, a straight line, or a shape formed by a combination thereof. The area of the second air holes 11c in the xy plane is preferably sufficiently larger than that of the first spaces S1. For example, the area of each air hole 11c in the xy plane is 10 times or more as large as the area of each first space S1.

The area of each second air hole 11c in the xy plane is 10 times or more as large as the area of each first space S1. This configuration can facilitate separation of the refrigerant 120 and the refrigerating machine oil in the compressor 101. The configuration can also guide the separated refrigerating machine oil to the first spaces S1.

In each first core 11 and each second core 12, a minimum distance W2 from each air hole 11c to the shaft hole 11b is larger than the width W1 of the thin-core part 11e of the first core 11. For example, the minimum distance W2 from each air hole 11c to the shaft hole 11b is twice or more as large as the width W1 of the thin-core part 11e of the first core 11. In this case, a flow path of the refrigerant 120 in the compressor 101 can be obtained. In addition, in a case where the crankshaft 2 is fixed to the shaft hole 11b by shrink fitting, strength of the rotor 10 can be increased.

As illustrated in FIG. 9, the second core 12 includes clearances 11f each provided between each second magnet accommodation hole 11a and the corresponding permanent magnet 15, and second spaces S2 each provided in an end portion of the second magnet accommodation hole 11a in the circumferential direction of the rotor 10. The clearances 11f of the second core 12 will also be referred to as second clearances 11f. Each second space S2 of the second core 12 communicates with the second clearance 11f. Each second clearance 11f of each second core 12 communicates with the corresponding first space S1.

In the example illustrated in FIG. 9, the second spaces S2 are located in both end portions of each second magnet accommodation hole 11a in the circumferential direction. A region between each second space S2 and the outer peripheral surface of the rotor core 14 is a thin part (also referred to as a bridge part), and this thin part reduces magnetic flux leakage in a region between adjacent magnetic poles. While the electric motor 1 is disposed in the compressor 101, each second space S2 functions as a path in which refrigerating machine oil flows.

In the xy plane, the length of each permanent magnet 15 in the lateral direction is shorter than the length of each second magnet accommodation hole 11a in the lateral direction. Accordingly, the clearance 11f is provided between the second magnet accommodation hole 11a and the permanent magnet 15. A width t1 of each clearance 11f in the lateral direction of the second magnet accommodation hole 11a is, for example, 0.1 mm to 0.2 mm. Each clearance 11f is located on the outer side or inner side with respect to corresponding permanent magnet 15 in the radial direction of the rotor 10. If each clearance 11f of the second core 12 is located at the outer side of each permanent magnet 15 in the radial direction of the rotor 10, cooling effect on the permanent magnet 15 can be further enhanced.

Each first core 11 is, for example, an electromagnetic steel sheet. Each second core 12 is also an electromagnetic steel sheet, for example. At least one first core 11 and at least one second core 12 are stacked in the axial direction of the rotor 10. In the example illustrated in FIG. 10, the first core 11 and the second core 12 are alternately arranged in the axial direction of the rotor 10.

The first core 11 and the second core 12 do not necessarily need to be alternately arranged. It is sufficient that the rotor core 14 includes at least one first core 11 and at least one second core 12.

A thickness t3 of each first core 11 in the axial direction is, for example, a predetermined thickness within the range from 0.2 mm to 0.7 mm. The thickness t3 of each second core 12 in the axial direction is also a predetermined thickness within the range from 0.2 mm to 0.7 mm, for example. In this embodiment, t3=0.35 mm.

At least one first core 11 and at least one second core 12 are fixed by caulking. Thus, as illustrated in FIGS. 6 and 7, each first core 11 and each second core 12 include caulked parts 11d. In this embodiment, two electromagnetic steel sheets adjacent to each other in the axial direction (the first core 11 and the second core 12 in FIG. 10) are fixed by a V-shaped projection (i.e., V caulking). Thus, as compared to a method of fixing with a cylindrical projection (i.e., round caulking), the first core 11 and the second core 12 can be firmly fixed.

In the example illustrated in FIG. 10, the +z side of each caulked part 11d is a recess, and the −z side of each caulked part 11d is a projection. Thus, the recess of each caulked part 11d of each electromagnetic steel sheet (e.g., first core 11) is fitted onto the projection of each caulked part 11d of its adjacent electromagnetic steel sheet (e.g., second core 12). The length of each caulked part 11d in the axial direction is larger than the thickness t3 of one electromagnetic steel sheet (i.e., the first core 11 or the second core 12).

As illustrated in FIG. 10, a clearance 11g (also referred to as a third clearance 11g) is provided between two electromagnetic steel sheets (the first core 11 and the second core 12 in FIG. 10) adjacent to each other in the axial direction. While the electric motor 1 is disposed in the compressor 101, each clearance 11g functions as a path in which refrigerating machine oil flows. The width t2 of each third clearance 11g in the axial direction is smaller than the width t1 of the first clearance 11f of the first core 11, and smaller than the width t1 of the second clearance 11f of the second core 12. This configuration allows the separated refrigerating machine oil to easily pass through the first clearances 11f and the second clearances 11f, and easily flow on the surfaces of the permanent magnets 15. Consequently, the permanent magnets 15 can be cooled.

The width t2 of the third clearance 11g is smaller than the thickness t3 of one electromagnetic steel sheet (i.e., the first core 11 or the second core 12). The width t2 of the third clearance 11g is less than or equal to 1/10 of the thickness t3 of one electromagnetic steel sheet (i.e., the first core 11 or the second core 12). In this embodiment, the width t2 of the third clearance 11g is 10 μm or less. For example, the width t2 is a predetermined width within the range from 1 μm to 5 μm.

In this embodiment, each caulked part 11d is formed by V caulking, for example. Thus, since the first core 11 and the second core 12 are fixed by each caulked part 11d formed by V caulking, dimensional accuracy of the width t2 of each third clearance 11g is well secured compared to the case of round caulking.

As FIGS. 6 and 10, each first core 11 includes an oil introduction part 11h defining the first air hole 11c and facing the first space S1. That is, the oil introduction part 11h forms a part of the inner wall of the first air hole 11c. As illustrated in FIG. 10, the oil introduction part 11h tilts with respect to the axial direction of the rotor 10. Each oil introduction part 11h may be formed by a flat surface or may be formed by a curved surface. In the example illustrated in FIG. 10, each oil introduction part 11h is disposed at the +z side of the first air hole 11c. For example, in a case where the axial direction of the rotor 10 coincides with the vertical direction, each oil introduction part 11h is disposed above the first air hole 11c. In a case where the oil introduction part 11h is provided at the inner wall of the first air hole 11c, the separated refrigerating machine oil can be easily guided to the first spaces S1.

Each oil introduction part 11h is disposed at a position facing the first space S1. In other words, each oil introduction part 11h is formed at the inner wall of the first air hole 11c facing the first space S1.

As illustrated in FIG. 10, a first end plate 16a and a second end plate 16b are provided at both ends of the rotor core 14 in the axial direction. Specifically, the rotor 10 includes the first end plate 16a provided at one end of the rotor core 14 in the axial direction of the rotor 10 and the second end plate 16b provided at the other end of the rotor core 14 in the axial direction of the rotor 10.

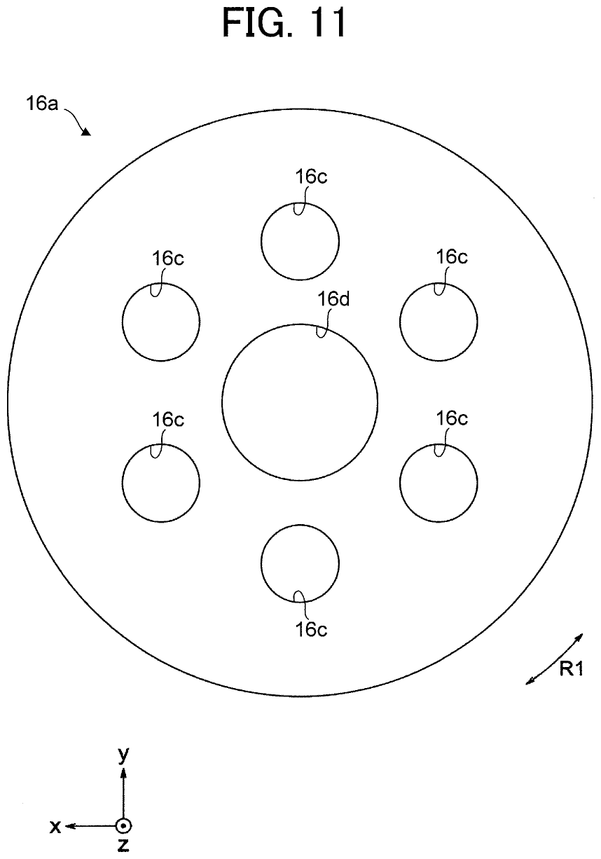

FIG. 11 is a plan view illustrating a configuration at the +z side of the first end plate 16a.

The first end plate 16a includes a plurality of air holes 16c (also referred to as third air holes 16c) and a shaft hole 16d. The third air holes 16c communicate with the first air holes 11c of each first core 11 and the second air holes 11c of each second core 12. The shaft hole 16d of the first end plate 16a communicates with the shaft hole 11b of the rotor core 14. The first end plate 16a covers the magnet accommodation holes 11a (i.e., the first magnet accommodation holes 11a of each first core 11 and the second magnet accommodation holes 11a of each second core 12) of the rotor core 14. Accordingly, since the magnet accommodation holes 11a of the rotor core 14 are closed with the first end plate 16a at one end, while the electric motor 1 is disposed in the compressor 101, outflow of refrigerating machine oil from the compressor 101 can be prevented.

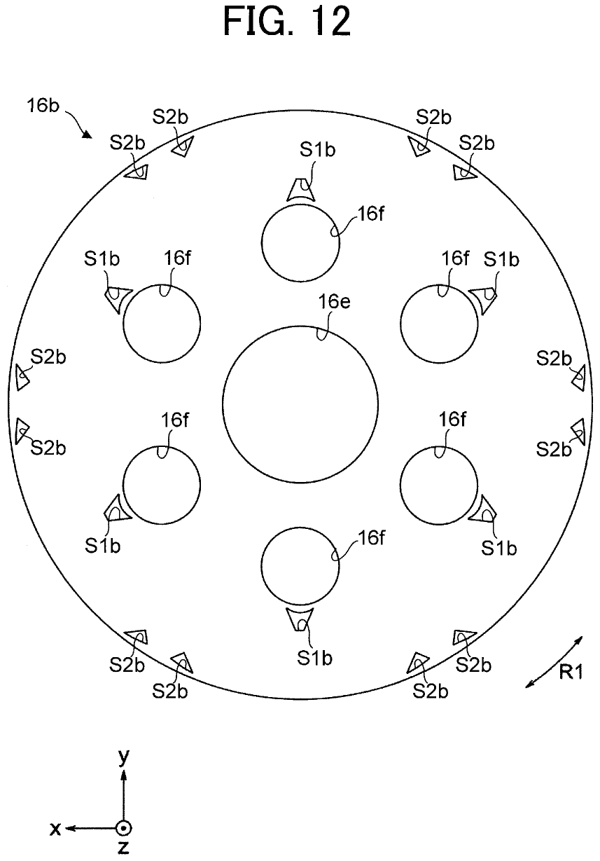

FIG. 12 is a plan view illustrating a configuration at the +z side of the second end plate 16b.

The second end plate 16b includes a plurality of third spaces S1b, a plurality of fourth spaces S2b, a shaft hole 16e, and a plurality of air holes 16f (also referred to as fourth air holes 16f). Each fourth air hole 16f communicates with corresponding first air hole 11c of the first core 11 and corresponding second air hole 11c of the second core 12. The third spaces S1b communicate with the first spaces S1 of the rotor core 14. The fourth spaces S2b communicate with the second spaces S2 of the rotor core 14. This configuration allows refrigerating machine oil to easily flow into the oil sump part 45. The shaft hole 16e of the second end plate 16b communicates with the shaft hole 11b of the rotor core 14.

### <Variations>

Another example of the rotor 10 will now be described.

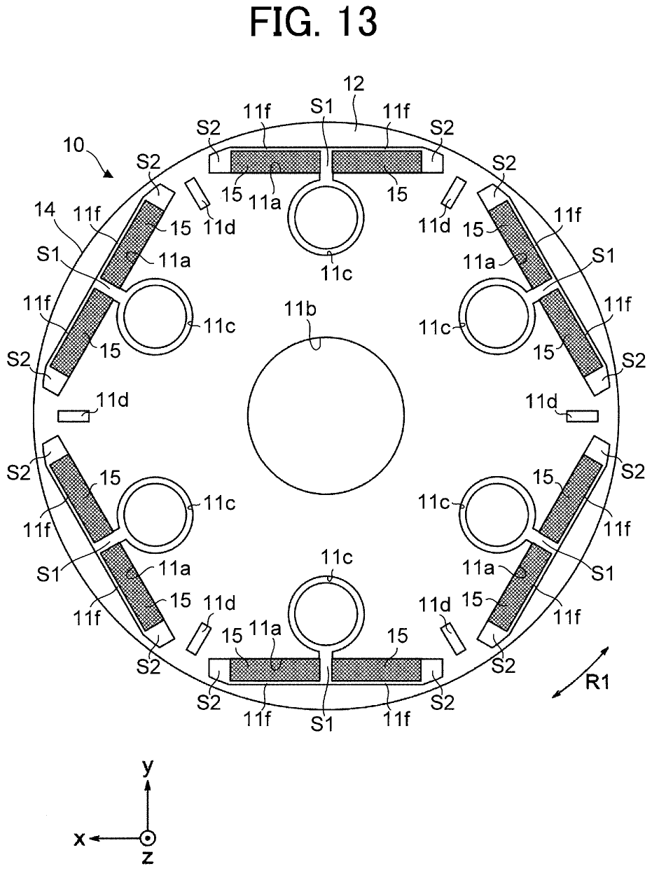

FIG. 13 is a cross-sectional view illustrating another example of the rotor 10.

The shape of each magnet accommodation hole 11a of the rotor core 14 in the xy plane is not limited to a V shape. For example, as illustrated in FIG. 13, the shape of each magnet accommodation hole 11a in the rotor core 14 in the xy plane may be a linear shape.

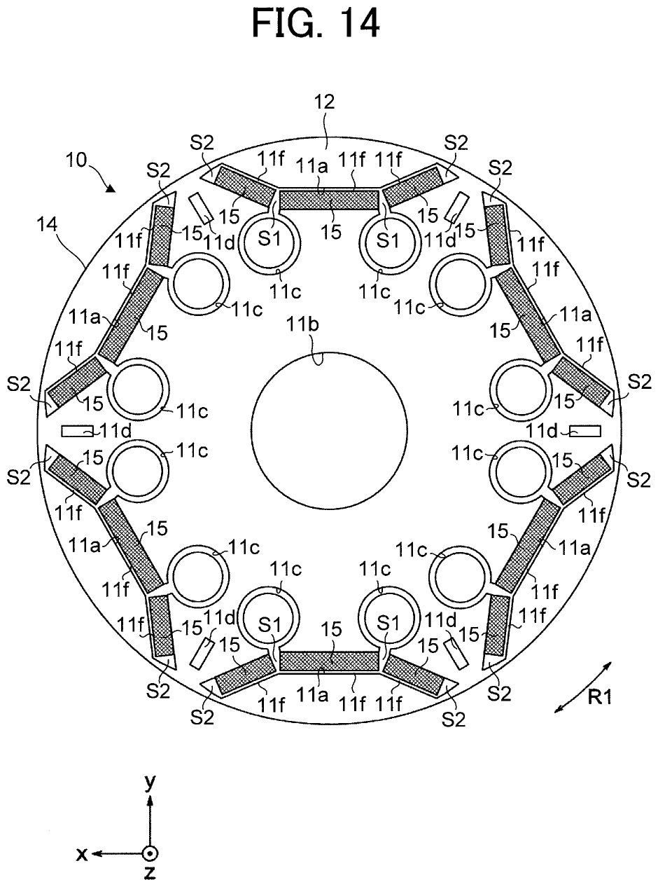

FIG. 14 is a cross-sectional view illustrating yet another example of the rotor 10.

As illustrated in FIG. 14, each side of each magnet accommodation hole 11a of the rotor core 14 in the longitudinal direction in the xy plane may be formed by three or more straight lines, three or more curves, or a combination thereof. In this case, three or more permanent magnets 15 may be disposed in each magnet accommodation hole 11a. In the example illustrated in FIG. 14, each side of each magnet accommodation hole 11a in the longitudinal direction is formed by three straight lines. Accordingly, each magnet accommodation hole 11a is recessed toward the axis C1. In the example illustrated in FIG. 14, three permanent magnets 15 are disposed in each magnet accommodation hole 11a.

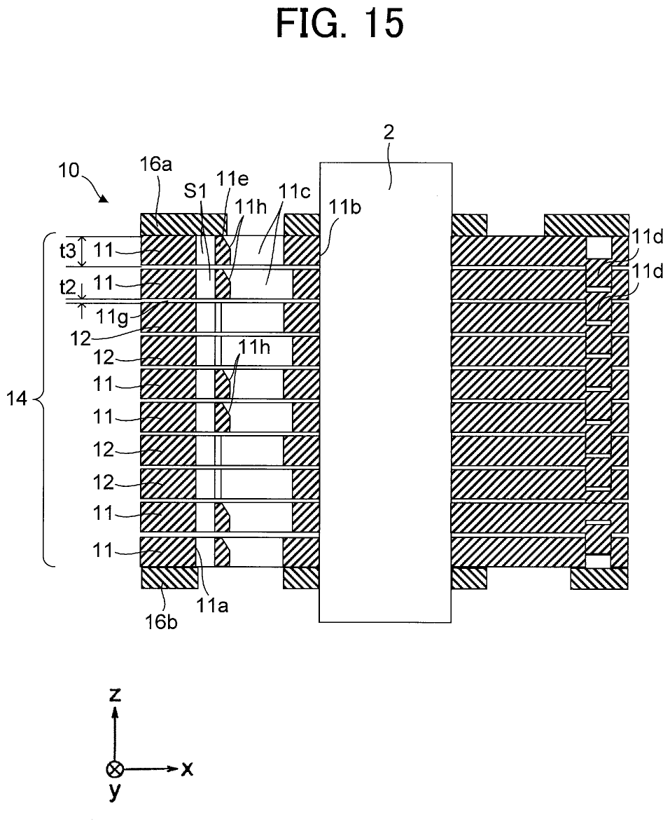

FIG. 15 is a cross-sectional view illustrating still another example of the rotor 10.

As illustrated in FIG. 15, the plurality of first cores 11 and the plurality of second cores 12 may be alternately arranged in the axial direction of the rotor 10. In the example illustrated in FIG. 15, two first cores 11 and two second cores 12 are alternately disposed in the axial direction of the rotor 10.

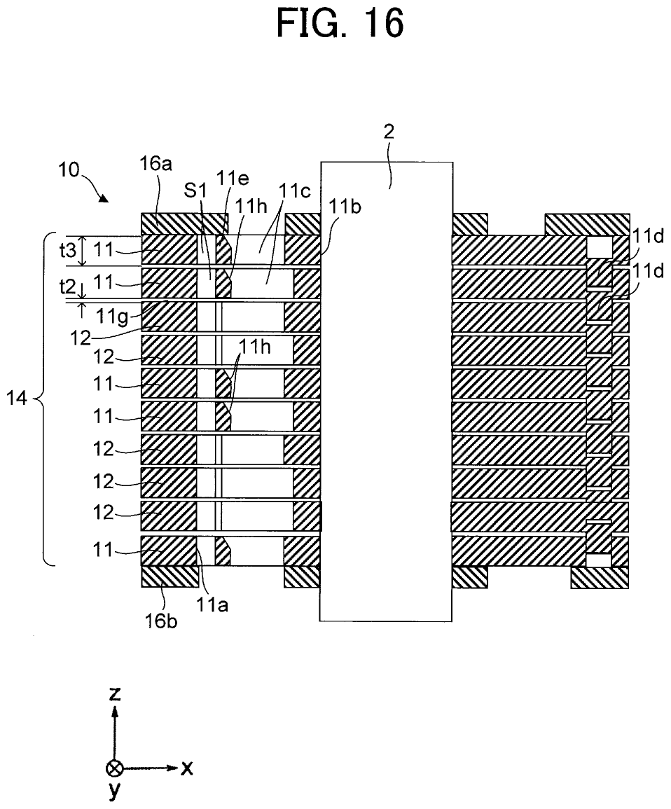

FIG. 16 is a cross-sectional view illustrating still another example of the rotor 10.

As illustrated in FIG. 16, a larger number of second cores 12 may be provided in a lower half of the rotor core 14 than in an upper half of the rotor core 14. Specifically, in a case where the axial direction of the rotor 10 coincides with the vertical direction, the number of second cores 12 occupying the lower half of the rotor 10 (specifically, the rotor core 14) is larger than the number of second cores 12 occupying the upper half of the rotor 10 (specifically, the rotor core 14).

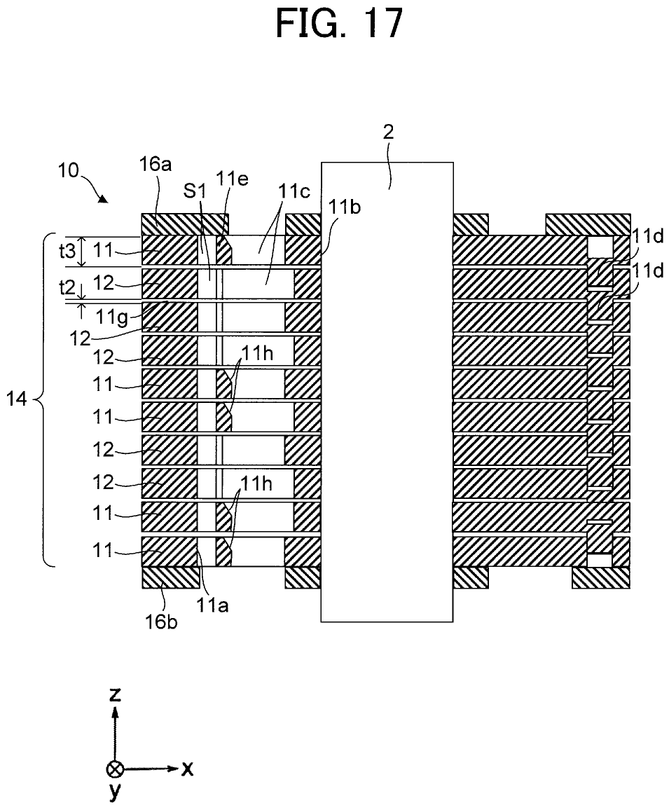

FIG. 17 is a cross-sectional view illustrating still another example of the rotor 10.

As illustrated in FIG. 17, a larger number of second cores 12 may be provided in an upper half of the rotor core 14 than in a lower half of the rotor core 14. Specifically, in the case where the axial direction of the rotor 10 coincides with the vertical direction, the number of second cores 12 occupying the upper half of the rotor 10 (specifically, the rotor core 14) is larger than the number of second cores 12 occupying the lower half of the rotor 10 (specifically, the rotor core 14).

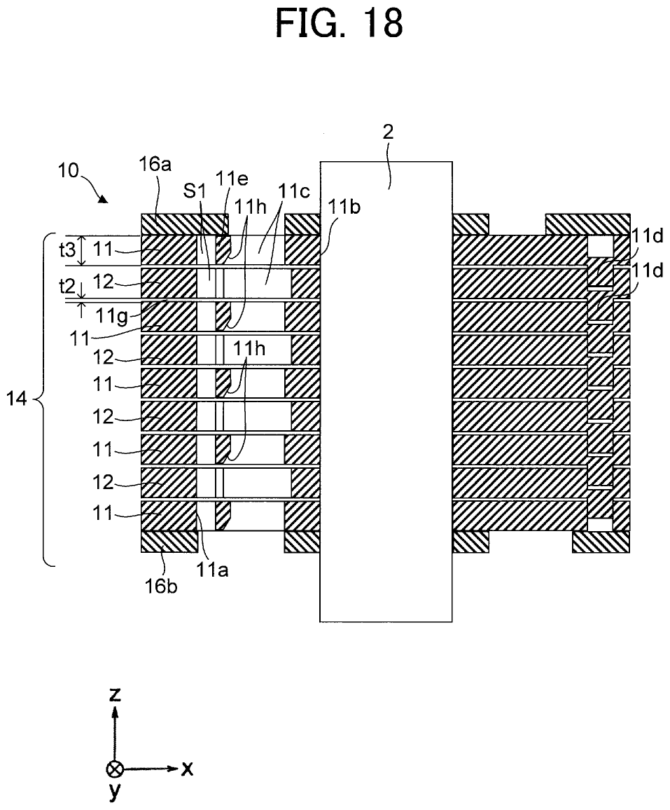

FIG. 18 is a cross-sectional view illustrating still another example of the rotor 10.

As illustrated in FIG. 18, each oil introduction part 11h may be provided at the −z side of the first air hole 11c. For example, in the case where the axial direction of the rotor 10 coincides with the vertical direction, each oil introduction part 11h may be disposed below the first air hole 11c. In a case where the oil introduction part 11h is provided at the inner wall of the first air hole 11c, the separated refrigerating machine oil can be easily guided to the first spaces S1.

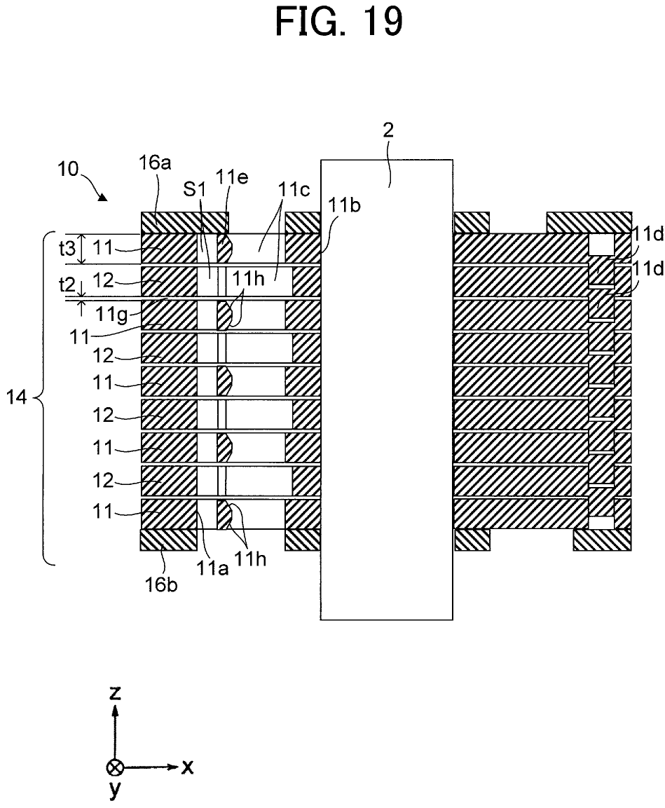

FIG. 19 is a cross-sectional view illustrating still another example of the rotor 10.

As illustrated in FIG. 19, the oil introduction part 11h may be provided at each of the +z side and the −z side of the first air hole 11c. For example, in the case where the axial direction of the rotor 10 coincides with the vertical direction, the oil introduction parts 11h may be disposed above and below the first air hole 11c. In a case where the oil introduction part 11h is provided at the inner wall of the first air hole 11c, the separated refrigerating machine oil can be easily guided to the first spaces S1.

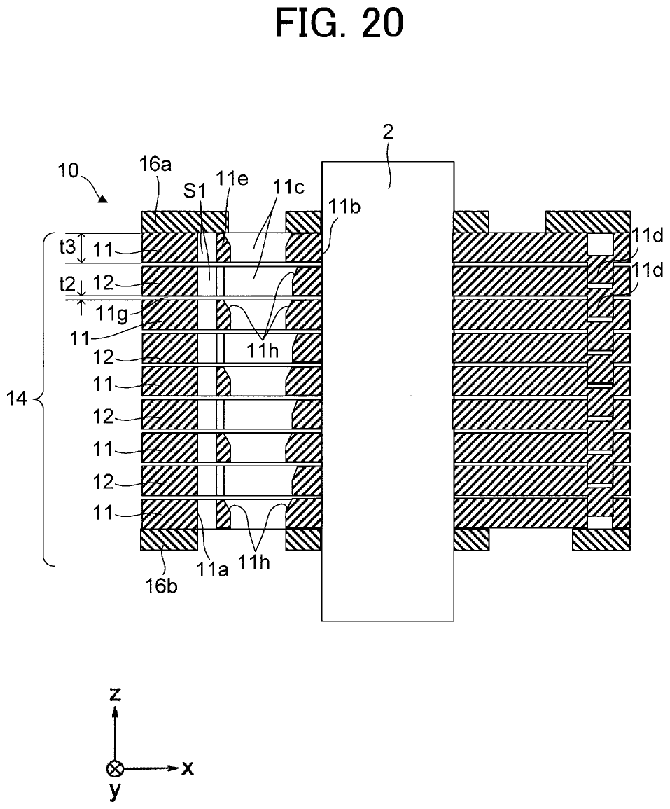

FIG. 20 is a cross-sectional view illustrating still another example of the rotor 10.

As illustrated in FIG. 20, each oil introduction part 11h may be disposed at a position not facing the first space S1. For example, the oil introduction parts 11h may be formed at all the inner walls of the first air holes 11c. In the case where the oil introduction parts 11h are provided at the inner walls of the first air holes 11c, the separated refrigerating machine oil may be easily guided to the first spaces S1. The oil introduction parts 11h may be provided at the inner walls of the second air holes 11c of the second core 12.

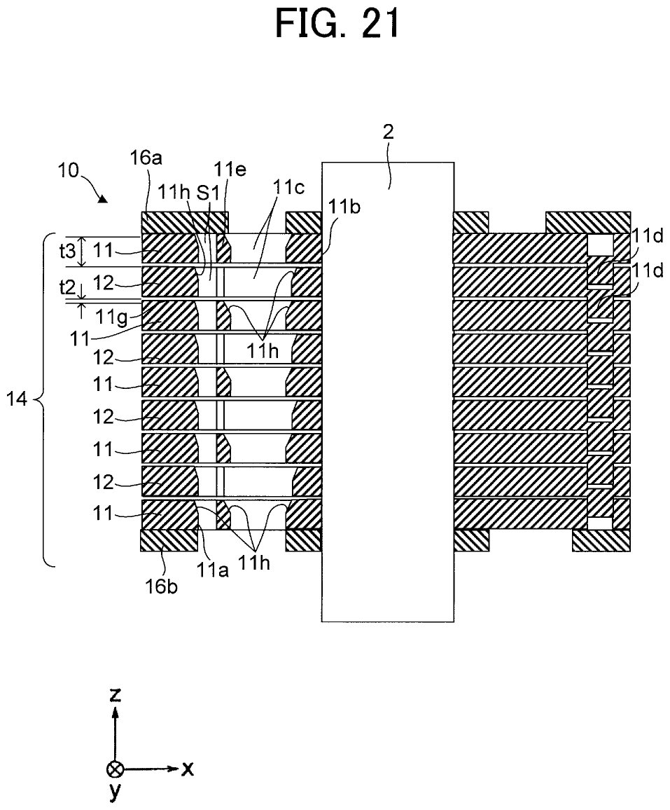

FIG. 21 is a cross-sectional view illustrating still another example of the rotor 10.

As illustrated in FIG. 21, the oil introduction parts 11h may be provided at the inner walls of the first spaces S1 of the first core 11. In this case, the oil introduction part 11h may be provided at the inner wall of the first space S1 at the outer side in the radial direction. The oil introduction parts 11h may be provided at the inner walls of the first spaces S1 of the second core 12. In this case, the oil introduction parts 11h may be provided at the inner walls of the first spaces S1 at the outer side in the radial direction.

The oil introduction parts 11h may also be provided at the inner walls of the second spaces S2 of the second core 11. In this case, the oil introduction parts 11h may also be provided at the inner walls of the second spaces S2 at the outer side in the radial direction. The oil introduction parts 11h may be provided at the inner walls of the second spaces S2 of the second core 12. In this case, the oil introduction parts 11h may be provided at the inner walls of the second spaces S2 at the outer side in the radial direction.

### <Operation of Compressor>

Next, an operation of the compressor 101 will be described. When a current is supplied from the terminal 42 to the electric motor 1, the rotor 10 of the electric motor 1 thereby rotates. With the rotation of the rotor 10, the crankshaft 2 rotates. As illustrated in FIG. 4, while the crankshaft 2 rotates, the rolling piston 32 and the eccentric shaft part 2b rotate in the direction indicated by arrow A about an axis eccentric to the axis C1. Accordingly, the low-pressure refrigerant 120 is sucked into the suction chamber 36a communicating with the suction port 31a.

The refrigerant 120 sucked into the suction chamber 36a is compressed by rotation of the rolling piston 32. Specifically, while the rolling piston 32 eccentrically rotates, the vane 33 reciprocates in the vane groove 31c to cause the refrigerant 120 sucked in the suction chamber 36a to move to the compression chamber 36b to be compressed. The refrigerant 120 compressed in the compression chamber 36b changes to a high-temperature and high-pressure refrigerant gas and is discharged from the upper discharge muffler 37 or the lower discharge muffler 38.

The refrigerant 120 discharged from the compression mechanism 3 changes to a gas refrigerant, is mixed with liquid refrigerating machine oil, and passes through the air holes 11c in the rotor 10 of the electric motor 1. The refrigerant is separated from the refrigerating machine oil in the air holes 11c, and the separated refrigerant is discharged from the discharge pipe 41 to the outside of the sealed container 4 and flows to the refrigerant channel 110.

Next, a principle in which refrigerant and refrigerating machine oil are separated from each other in the air holes 11c will be described. Since the area of the air holes 11c of the second core 12 in the xy plane is larger than the area of the air holes 11c of the first core 11 in the xy plane, the inner wall of the air holes 11c of the rotor core 14 has an uneven structure (also referred to as an uneven portion) along the axial direction. Separation between the refrigerant and the refrigerating machine oil is facilitated due to a collision with this uneven portion when the refrigerant and the refrigerating machine oil pass through the air holes 11c.

In the air holes 11c, with rotation of the rotor 10, a centrifugal force is exerted on the refrigerant and the refrigerating machine oil. This centrifugal force causes the refrigerating machine oil having a larger specific gravity is distributed outward in the radial direction, and a gas refrigerant having a smaller specific gravity is distributed inward in the radial direction. The oil introduction part 11h causes the refrigerating machine oil to pass through the communication portion between magnet accommodation holes 11a and the air holes 11c in the second core 12 and the thin-core parts 11e of the first core 11, and flow into the first spaces S1. While the rotor 10 rotates, refrigerating machine oil that has flowed into the first spaces S1 is caused to flow into the clearances 11f and the second spaces S2 by the centrifugal force, and flows into the oil sump part 45 by gravity.

As described above, in this embodiment, even in the case of increasing the flow rate of refrigerant, separation between the refrigerant 120 and the refrigerating machine oil in the compressor 101 can be facilitated, and an outflow of the refrigerating machine oil in the compressor 101 from the compressor 101 can be prevented. Accordingly, poor lubrication in the compression mechanism 3 of the compressor 101 can be prevented. As a result, degradation of performance of the refrigeration cycle device and the air conditioner 100 can be suppressed, and the refrigeration cycle device and the air conditioner 100 having high reliability can be obtained.

1. A rotor comprising:
at least one first core;
at least one second core; and
two or more permanent magnets, wherein
the at least one first core includes a first magnet accommodation hole, a first air hole located apart from the first magnet accommodation hole inward in a radial direction, and a thin-core part located between the first magnet accommodation hole and the first air hole,
the at least one second core includes a second magnet accommodation hole axially communicating with the first magnet accommodation hole, and a second air hole communicating with both of the second magnet accommodation hole and the first air hole,
a first permanent magnet and a second permanent magnet of the two or more permanent magnets are disposed in the first magnet accommodation hole and the second magnet accommodation hole, and
a first space is provided between the first permanent magnet and the second permanent magnet that are disposed in the first magnet accommodation hole and the second magnet accommodation hole.

2. The rotor according to claim 1, wherein in a plane orthogonal to an axial direction of the rotor, the second air hole has an area larger than an area of the first air hole.

3. The rotor according to claim 1, wherein the at least one first core includes an oil introduction part defining the first air hole and facing the first space.

4. The rotor according to claim 3, wherein the oil introduction part tilts with respect to an axial direction of the rotor.

5. The rotor according to claim 1, wherein
in a plane orthogonal to an axial direction of the rotor, the first magnet accommodation hole has a V shape, and
in the plane, the second magnet accommodation hole has a V shape.

6. The rotor according to claim 5, wherein in the plane, the first permanent magnet and the second permanent magnet are disposed in a V shape.

7. The rotor according to claim 1, wherein the first core and the second core are alternately disposed in an axial direction of the rotor.

8. The rotor according to claim 1, wherein in a state where an axial direction of the rotor coincides with a vertical direction, the at least one second core occupying an upper half of the rotor is larger in number than the at least one second core occupying a lower half of the rotor.

9. The rotor according to claim 1, wherein
the first core has a first clearance between the first magnet accommodation hole and the permanent magnets, and
the first clearance communicates with the first space.

10. The rotor according to claim 9, wherein
the second core has a second clearance between the second magnet accommodation hole and the permanent magnet, and
the second clearance communicates with the first space.

11. The rotor according to claim 10, wherein the first clearance and the second clearance are located at an outer side of the two or more permanent magnets in a radial direction of the rotor.

12. The rotor according to claim 11, wherein
the first core includes a second space located in an end portion of the first magnet accommodation hole in a circumferential direction of the rotor, and
the second space of the first core communicates with the first clearance.

13. The rotor according to claim 11, wherein
the second core includes a second space located in an end portion of the second magnet accommodation hole in a circumferential direction of the rotor, and
the second space of the second core communicates with the second clearance.

14. The rotor according to claim 13, further comprising:
a rotor core including the at least one first core and the at least one second core;
a first end plate disposed at an end of the rotor core in an axial direction of the rotor; and
a second end plate disposed at another end of the rotor core in the axial direction, wherein the first end plate has a third air hole communicating with the first air hole and the second air hole, and covers the first magnet accommodation hole and the second magnet accommodation hole, and
the second end plate includes a third space communicating with the first space, and a fourth space communicating with the second space.

15. An electric motor comprising:
a stator; and
the rotor according to claim 1, the rotor being disposed inside the stator.

16. A compressor comprising:
the electric motor according to claim 15;
a compression mechanism; and
a crankshaft couples the compression mechanism and the electric motor together.

17. A refrigeration cycle device comprising:
the compressor according to claim 16 to compress a refrigerant; and
a refrigerant channel in which the refrigerant compressed by the compressor flows.

18. An air conditioner comprising:
the compressor according to claim 16;
an outdoor heat exchanger; and
an indoor heat exchanger.

19. The rotor according to claim 2, wherein the at least one first core includes an oil introduction part defining the first air hole and facing the first space.

20. The rotor according to claim 12, wherein
the second core includes a second space located in an end portion of the second magnet accommodation hole in a circumferential direction of the rotor, and
the second space of the second core communicates with the second clearance.
